(19) United States
(12) Patent Application Publication
(10) Pub. No.: US 2015/0026032 A1
(43) Pub. Date: Jan. 22, 2015

(54) MARKET TRADING

(71) Applicant: Perfectna, Carlsbad, CA (US)

(72) Inventor: Daniel G. Pena, San Diego, CA (US)

(21) Appl. No.: 14/334,640

(22) Filed: Jul. 17, 2014

Related U.S. Application Data
(60) Provisional application No. 61/847,511, filed on Jul. 17, 2013.

(51) Int. Cl. G06Q 40/04

(52) U.S. Cl. CPC G06Q 40/04
USPC 705/37

(57) ABSTRACT

An interaction facilitating platform conveys interactions between an individual investor and one or more traders to establish a binding agreement that can define investments made with the individual investor's funds based upon the one or more trader's transactions in a market.

### CROSS-REFERENCE TO RELATED APPLICATION

This application claims priority to U.S. Provisional Patent Application Ser. No. 61/847,511, filed Jul. 17, 2013, titled “Market Trading,” the disclosure of which is hereby incorporated by reference herein in its entirety.

### TECHNICAL FIELD

The subject matter described herein relates to market trading, particularly foreign exchange currency market trading via electronic means involving an investor, one or more traders, and a system that provides a platform for creating a binding agreement regarding interaction between the investor and the one or more traders.

### BACKGROUND

Trading through the markets enables banks, large corporations, investment firms, and individual investors to conduct transactions involving financial instruments such as foreign currency, stocks, bonds, and the like. Currency exchange can be for the purpose of enabling business transactions or for investment purposes. Investing through currency exchange can utilize many financial instruments. These financial instruments can be employed by individuals and organizations, such as hedge funds and banks. Currency trading can be an attractive investment tool, as the assets are much more liquid, that is to say readily available, compared to other investments, such as real estate, bonds, or stocks.

The foreign exchange market and currency trading can involve the use of many types of financial instruments including foreign exchange spots, forward agreements, foreign exchange swaps, currency futures, and foreign exchange options. All of these instruments and the exchange of these instruments can be intricate and require more time and contemplation than a retail, individual investor wishes to use on these types of investments. However, the individual investor can be attracted to the liquidity of the currency exchange market. Selecting a trader to work with, to entrust the handling of funds to, can also be daunting for the individual investor.

### SUMMARY

In light of the complexities described above, a way to aid an individual investor in selecting one or more qualified traders to work with, and to aid in entering into a legally binding agreement with the selected trader(s) is needed.

In one aspect, a system that includes an investor, an interaction facilitating platform, one or more traders, and a market for financial instruments is described. In a related aspect, methods are described in which an investor and one or more traders interact with an interaction facilitating platform to cause investments in the currency market using the investor's funds.

In a related aspect, an interaction platform is provided that includes an agreement processor and a trading core processor. The agreement processor may establish a binding agreement by an individual investor, in which the binding agreement defines investments to be made with funds associated with the individual investor based upon one or more traders in a market. The trading core processor can convey interactions between the one or more traders and the individual investor, in which the interactions include trade transactions by the one or more traders in the market. The trade transactions can include a mimicked trade on behalf of the individual investor that mimics at least one of the trade transactions by the one or more traders in the market.

The following features may be present in the interaction facilitating platform in any suitable combination. The interaction facilitating platform may further include a display processor for generating a visual display for the trade transactions by the one or more traders. In such implementations, the trading core processor may transmit the visual display of the trade transactions to a display device associated with the individual investor. The agreement processor of the interaction facilitating platform may include a screening module for pre-screening the one or more traders or the individual investor according to a set of pre-screening attributes in some implementations. In such implementations, the pre-screening attributes may include work history, education, and certification. Alternatively, or additionally, in such implementations, the pre-screening attributes may include a predetermined range of percentages of gains from an investment made by the individual investor who has entered into the agreement.

Implementations of the current subject matter can include, but are not limited to, systems and methods consistent with including one or more features are described, as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a schematic showing the interactions in an exemplary system described herein;

FIG. 2A is a flow diagram showing a potential interaction between an investor and a trader using an exemplary interaction facilitating platform in which the interaction is initiated by the investor;

FIG. 2B is another view of a flow diagram showing a potential interaction between an investor and a trader using an exemplary interaction facilitating platform in which the interaction is initiated by the investor;

FIG. 3 is a flow diagram showing a potential interaction between an investor and a trader using an exemplary interaction facilitating platform in which the interaction is initiated by the trader; and

FIG. 4 is a flow diagram showing actions that can take place in an exemplary system with an investor, a trader, an interaction facilitating platform, and a currency exchange market.

When practical, similar reference numbers denote similar structures, features, or elements.

### DETAILED DESCRIPTION

To address these and potentially other issues with currently available solutions, methods, systems, articles of manufacture, and the like consistent with one or more implementations of the current subject matter can, among other possible advantages, provide a way to facilitate selecting one or more qualified currency traders to work with and enter into a legally binding agreement with the selected trader(s) for an individual investor.

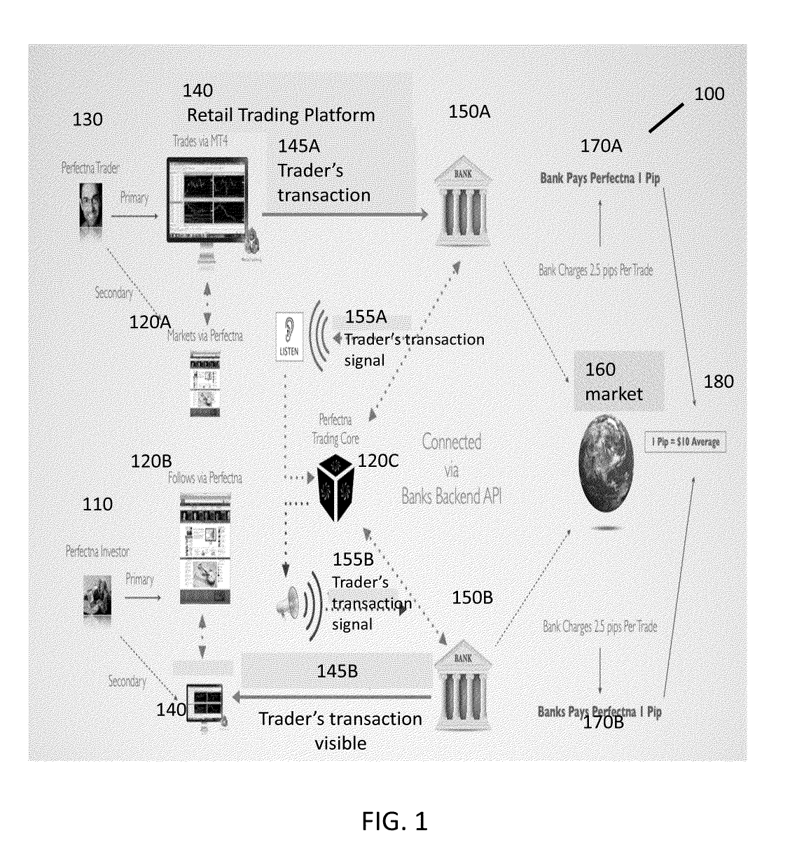

FIG. 1 is a schematic 100 showing the interactions in an exemplary system for joining an investor 110 and at least one trader 130 via a binding agreement and for executing trades on behalf of the investor 110 on the market 160. In the system, there is an investor 110, an interaction facilitating platform 120, one or more selected traders 130, and a market 160, such as a currency exchange market, a stock market, or any other suitable market for purchasing and selling financial instruments. Also present in the system are one or more banks 150A, 150B; one or more commission bank accounts 170A, 170B; transactions initiated by a trader 145A; echoes or indicators of transactions initiated by a trader 145B, and transaction signals 155A, 155B that correspond to the transactions initiated by a trader 145A.

The interaction facilitating platform 120 includes an agreement processor to establish a binding agreement by an individual investor, where the binding agreement defines investments to be made with funds associated with the individual investor based upon trade transactions by one or more traders in a market. The interaction facilitating platform 120 further includes a trading core processor 120C that conveys interactions between the one or more traders and the individual investor. The interactions can be digital representations of trade transactions by the one or more traders in the market, and the trade transactions can include a mimicked trade on behalf of the individual investor that mimics at least one of the trade transactions by the one or more traders in the market.

In making fiscal transactions, the system 100 can operate in the following manner. An investor 110 and a trader 130 can be bound by an agreement, which can only be terminated by the investor 110, in which the investor 110 chooses to emulate certain fiscal transactions made by the trader 130 using a portion of his or her money in a bank account linked to his or her investment profile that is associated with the interaction facilitating platform 120. The trader 130 chooses to execute a fiscal transaction using a retail trading platform 140. For example, the trader 130 can be active in the foreign currency exchange market and can use MT4 as his or her retail trading platform 140. In this example, the trader 130 is buying Euros (EUR) with United States dollars (USD) using MT4. The trader 130 can have a certain amount, say $100,000, in total at his or her disposal, but at this time chooses to invest only 10%, or $10,000, in this transaction. He or she can instigate this transaction using the retail trading platform 140 (e.g. MT4) and the transaction 145B can be communicated to the interaction facilitating platform 120, as well as his or her bank 150A. The trader's transaction signal 155A can be transmitted from the trader's bank 150A to the interaction facilitating platform 120C. The trader's bank 150A transacts with the market 160 to execute the transaction indicated by the trader 130. The interaction facilitating platform 120C conveys the trader's transaction signal 155B to the investor's bank 150B. The investor's bank 150B transacts with the market 160 to execute an transaction using the investor's funds that emulates the trader's transaction, e.g. 10% of the investor's funds can be used to buy Euros with the US dollars. The investor's bank 150B can transmit information on the trader's transaction 145B to the retail trading platform 140, to which the investor has access through the interaction facilitating platform 120B.

In the above scenario, when the trader's transaction is executed on the market 160, the trader's bank 150A charges a fee to the trader 130, and the bank in turn remits payment to a commission bank account 170A that is associated with the interaction facilitating platform 120. Similarly, when the investor's transaction is executed on the market 160, the investor's bank 150B charges a fee to the investor 110, and the bank in turn remits payment to a commission bank account 170A that is associated with the interaction facilitating platform 120.

The interaction facilitating platform as seen by the trader 120A can be the same as the interaction facilitating platform seen by the investor 120B. Alternatively, interaction facilitating platform as seen by the trader 120A can differ in appearance and available functions from the interaction facilitating platform seen by the investor 120B. The interaction facilitating platform 120 can include a back end, or core, 120C which processes transaction signals 155A, 155B, but that does not directly display information to, or receive input from, either the trader 130 or the investor 110.

In the system and methods described herein, the investor 110 does not communicate with the one or more selected traders 130 directly. Communication between the investor 110 and the traders 130 that he or she selects occurs solely through the interaction facilitating platform 120. Even the process of selecting one or more traders 130 is accomplished by the investor 110 through the interaction facilitating platform 120. Further, the investor 110 interacts with the market 160 primarily indirectly, that is to say through the interaction facilitating platform 120. The investor 110 can choose, on occasion, to invest in the market in a more direct manner, utilizing a retail trading platform 140.

The interaction facilitating platform 120 can include a software application, a web site, algorithms for calculating risk, algorithms for determining compatibility between traders and investors, agreement generating algorithms and software, one or more computer servers, graphical user interfaces, dedicated devices for interaction between an investor or trader and an application that communicates with a server, and the like. Mobile computing devices, including mobile phones, smart-phones, tablet devices, mobile computers, and the like can be supported, that is to say use with, the interaction facilitating platform 120.

The one or more traders 130 in the system can be pre-screened by the interaction facilitating platform 120. Pre-screening can include verification of work history, education degrees, and certifications. Pre-screening can also include confirmation that each trader accepted by the system agrees to a predetermined range of percentages of the gains from investment made by an investor who has entered into a binding agreement with him or her, as well as to a predetermined amount of activity on the currency exchange market to prevent nullification of binding agreements.

The interaction facilitating platform can select only the best traders to participate in interactions with investors. The traders who are invited to participate with investors via the interaction facilitating platform are vetted based upon multiple performance metrics. The performance metrics can include profit factor, annualized return, win loss ratio, max draw down, monthly downside deviation, monthly standard deviation, total trades, experience, and the like in any suitable combination. The interaction facilitating platform can provide the information on the various participating traders so that the individual investors can make educated selections using information, including the performance metrics and the behavioral analytics for each trader. For example, the investor can decide that though a trader has an annual slow period, that he or she will follow the trader for a longer term period, such that the cumulative trend will lead to a gain for the individual investor following the trader.

The binding agreement between an investor 110 and a trader 130 can be long term or can be of an indeterminate duration. The binding agreement can be terminated by the investor at any time. In some implementations, the binding agreement can set out a success fee and a management fee to be paid by the investor 110 to the interaction facilitating platform 120 via a commission bank account 170A, 170B. The success fee and management fee can be calculated to correlate an annual rate to a monthly rate or a daily rate, and the investor 110 can be charged by the interaction facilitating platform 120 on a regular basis, such as weekly basis, a monthly basis, or a quarterly basis. The interaction facilitating platform 120 can in turn pay the agreed upon success fee, as outlined in the binding agreement, to the trader 130. The success fee can be contingent upon a gain in funds for the investor 110. The success fee that the trader 130 requires to be paid by an investor who chooses to make transactions to emulate him or her can vary in each binding agreement, such as based upon the date that the binding agreement is entered into by both parties, based upon the funds allocated by an investor to transactions that follow the trader, or both. The success fee will not be paid by the investor directly to the trader; no direct funds transfers will be made between the investor and trader, and it is possible that no direct communication takes place between the investor and trader.

A relationship between a currency trader 130 and an individual investor 110 in the systems and methods described herein is created by each party utilizing the interaction facilitating platform 120, that is to say each trader and each individual investor sends and receives information to and from, respectively, the interaction facilitating platform 120. This relationship between the individual investor and one or more trader begins with a negation process. The negotiation process is the process by which a trader and an investor agree upon the variable terms to be used in the agreement between them. The variable terms include the success fee and the monetary amount to be invested by the investor with the trader. The negotiation process is a way for the investor to invest at a more favorable (i.e. lesser) rate than the trader's current asking success fee.

A negotiation process can find itself in one of three stages: the initial offer, the counter offer, and the end of the offer, whereby only the initial offer and the end of the offer are necessary for a full negotiation. The end of the offer includes the acceptance, rejection, and expiration of the offer.

Either an individual investor or a trader can initiate a negotiation by sending an offer to the other party. The initial offer minimally includes the initial success fee bid and the monetary amount of the investment. The initial offer can be marked with the date and time at which the offer expires if the other party does not react. Optionally, the initial offer can be marked as a best and final offer.

The other party can accept the offer, reject the offer, or make a counter offer. A counter offer can only be made if the previous offer was not a best and final offer. The counter offer must including a success fee bid that is between the value of the current offer and the previous offer. Like the initial offer, the counter offer must be marked with the date and time at which the offer expires if the other party does not react. Optionally, the counter offer can be marked as a best and final offer. The trader and the investor can send counter offers back and forth indefinitely until the negotiation is concluded by either an acceptance, rejection or the expiration of the time limit of the current offer.

If an offer made during the negotiation process is rejected by either party or the time limit of the current offer expires, the negotiation process concludes, and an agreement between the trader and investor is not entered into. On the other hand, if an offer is accepted, the negotiation process concludes and can result in a binding agreement between the trader and investor, with the success fee being set at the success fee of the current offer. Over time, an investor can be rewarded for his or her loyalty in following the same trader continuously by earning a reduced management fee or a reduced success fee.

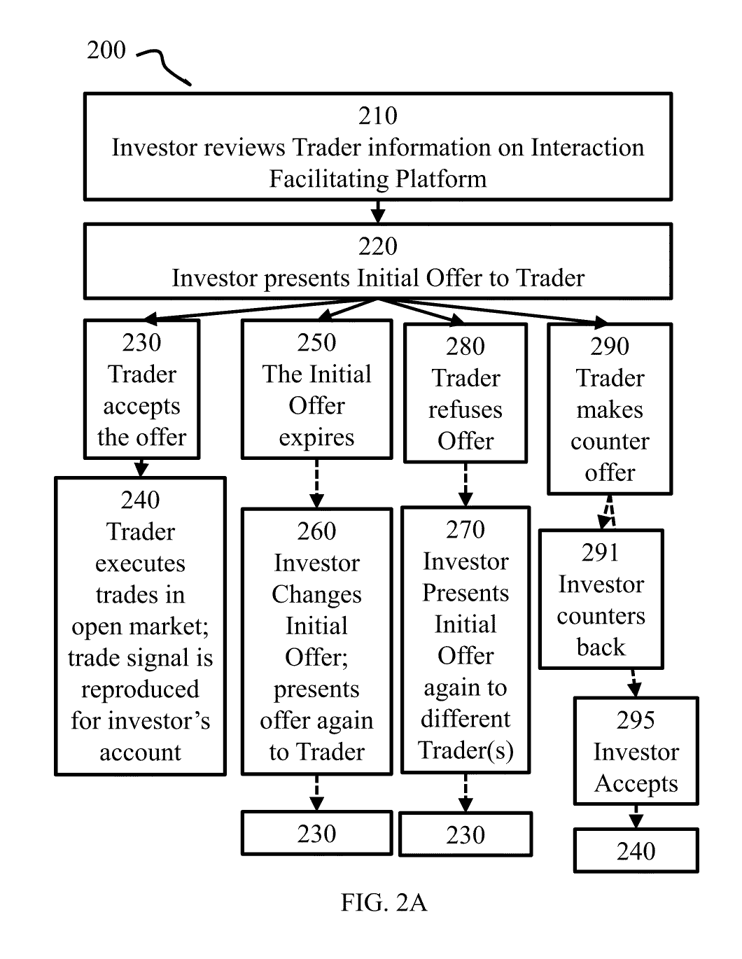

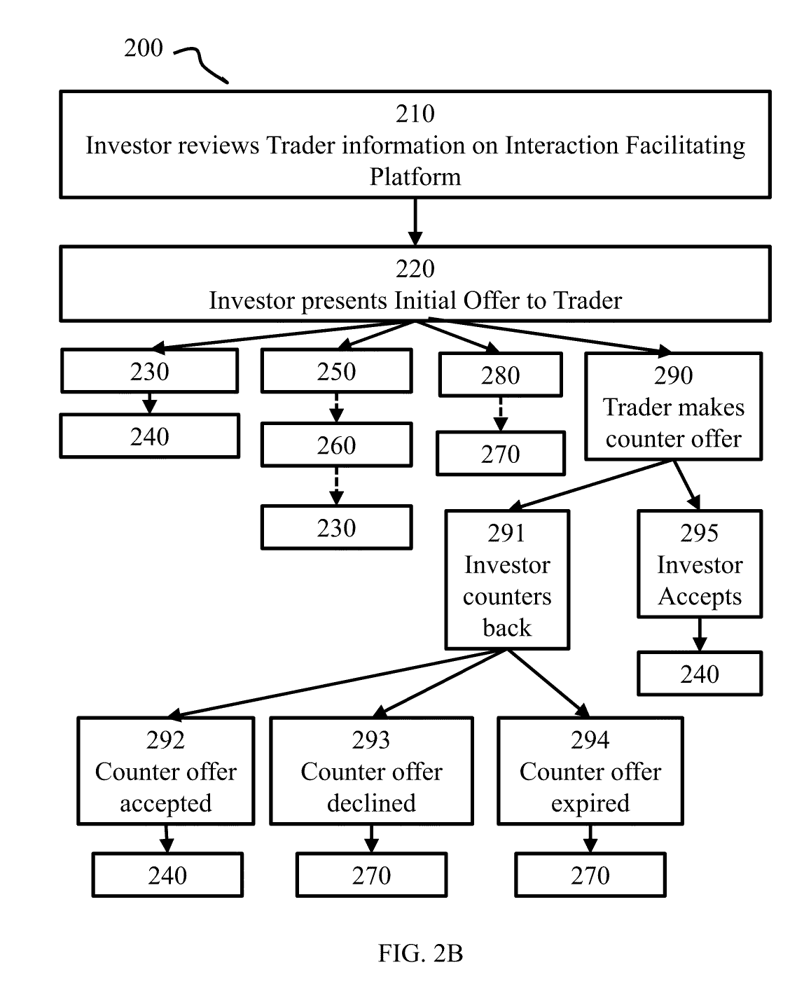

FIG. 2A is a flow diagram showing a potential negotiation process and interaction 200 between an investor and a trader using an exemplary interaction facilitating platform in which the interaction is initiated by the investor. Initially, the interaction proceeds with the investor reviewing information pertaining to available traders on the interaction facilitating platform, as in box 210. After reviewing the information, and perhaps receiving some guidance on trader selection from the interaction facilitating platform, the investor presents an initial offer, as described above, to at least a trader, as in box 220. At this point, the trader approached by the individual investor can accept the offer, as in box 230. Following this, the trader can execute transactions on the currency exchange market, as in box 240. These transactions can cause the interaction facilitating platform to invest portions of the individual investor's funds, as detailed below.

Also shown in FIG. 2A, after the investor presents the initial offer to one or more trader, 220, the initial offer can expire, 250. Expiration can occur because the time period for consideration was shorter than the parties needed for contemplating the offer or for counter-offering or for other reasons. Once the initial offer expires, the individual investor can change the initial offer and present the revised offer to the same trader, as in box 260. If the trader refuses the initial offer, as in box 280, the individual investor can present the same initial offer to one or more different traders, as in box 270. After either type of presenting an initial offer again, box 260 or 270, at least one selected trader can accept the offer, as in box 230.

After the investor presents the initial offer 220, the trader can make a counter offer, as in box 290. FIG. 2A shows that the investor can counter back 291, or accept the counter offer 295, and in turn have the trader make trades which are reproduced in the investor's account 240.

FIG. 2B shows in greater detail what can happen after the trader makes a counter offer 290. As in FIG. 2A, the investor can present a counter offer back to the trader, 291. Following the investor makes his or her counter offer, a number of things can occur. The trader can accept the investor's counter offer 292, and subsequently the trader can execute trades in the currency market and the trade signal can be reflected in the investor's account 240. Alternatively, the trader can decline the investor's counter offer 293. At this point, the interaction can end, or the investor can present his or her offer to another trader 270. Further, following the investor's counter offer to the trader 291, the counter offer can be let of expire 294. As when the counter offer is declined, then the interaction can end, or the investor can present his or her offer to another trader 270.

As mentioned above, the negotiation process can end if either party refuses the current offer. In the exemplary scenario 200, this can include the trader(s) refusing the initial offer or a subsequent offer, or the individual investor can refuse a counter offer. Either of these refusals occurring before the current offer expires ends the negotiation process.

Also to be noted is that though FIG. 2A and FIG. 2B are described with respect to one investor and one trader, more than one trader can be approached by the investor during the initial offer or during a follow-on offer.

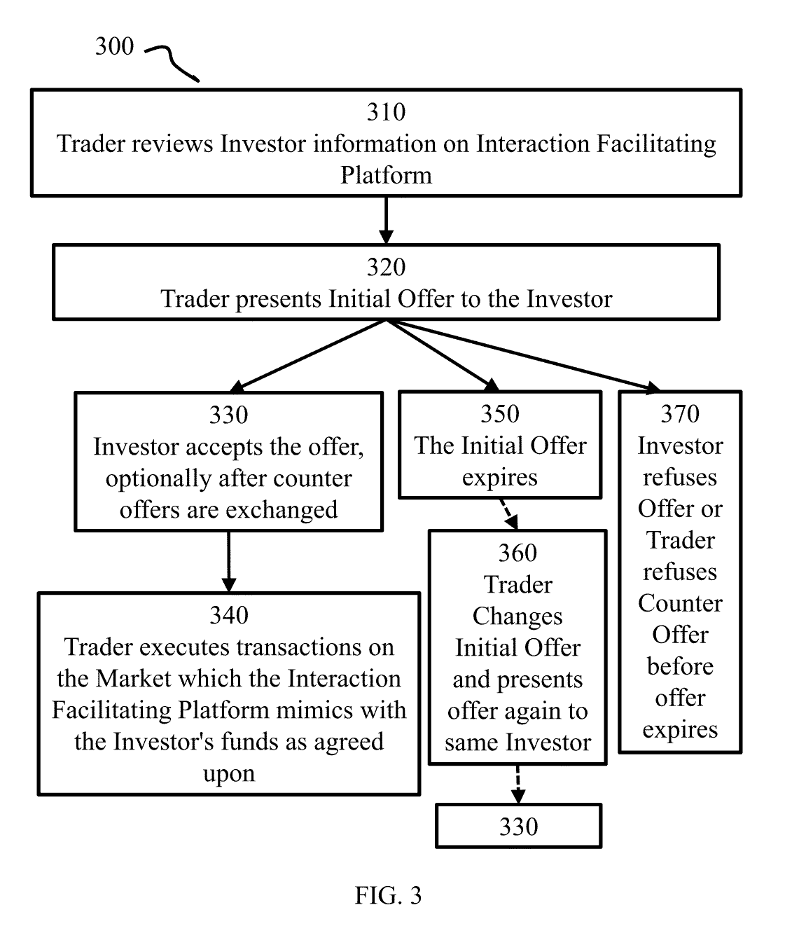

FIG. 3 is a flow diagram showing a representative negotiation process and potential interaction 300 between an investor and a trader using an exemplary interaction facilitating platform in which the interaction is initiated by the trader. The trader can be presented with information regarding participating individual investors by the interaction facilitating platform, as in box 310. After selecting an individual investor, the trader can present an initial offer to the investor via the interaction facilitating platform, as shown in box 320.

As mentioned above, and similar to the process shown in FIG. 2, after the presentation of the initial offer 320, there can be three different subsequent events. Box 330 shows that the investor can accept the offer, and perhaps it is not the initial offer, but a subsequent counter offer. Once the current offer is accepted, both parties will enter into a binding agreement as described above. The trader can then execute transactions on the market which the interaction facilitating platform can mimic using the individual investor's funds, as in box 340.

Alternatively, the initial offer can expire, box 350, for the same reasons given above. In response to an expired offer, the trader can change his or her initial offer and present it to the same individual investor, as in box 360. At this point, the investor can accept the offer, and the flow of events can coincide with those in box 330. Further, either party can refuse the current offer before the expiration of the offer, as in box 370. This refusal ends the negotiation process.

Direct communication or correspondence between the investor and the trader can be discouraged by the interaction facilitating platform, as traders are not permitted to coach or advise investors in making investment choices. The nature of the possible investment choices is explained in further detail below, using foreign currency exchange as an example.

An investor can choose to invest a portion of his or her investing bank account, e.g. foreign currency exchange (i.e. Forex) account, into mimicking trade signals of a particular trader. This means that once the investor and the trader have established a binding investment agreement, through the interaction facilitating platform, thereafter, any time the trader makes a transaction in a market, such as a trade on a currency pair through his or her foreign currency exchange account, a similar transaction will automatically be made with funds from the investor's investing account. This process of mimicking the trader's trade on the investor's account will be referred to as “following” a trade. The monetary amount traded on the investor's account for a trade being followed will not necessarily be equal to the amount traded by the trader in the original trade. To determine the amount to be traded for the followed trade using the investor's account, a mathematical formula is used which ensures that the level of risk for that given trade is equal to the level of risk of the trader's original trade.

At any time, the investor has the option of choosing which transactions made by the given trader to follow and which transactions not to follow. In some instances, the investor can choose to only follow transactions involving particular financial instruments, such as certain stocks, particular currency pairs, and the like. In other instances, an individual investor can choose to follow the trades of another successful, individual investor made through the interaction facilitating platform. In such instances, the investor following the successful investor is in effect following an aggregate of traders and will remit success fees to those traders through the interaction facilitating platform, and potentially, the investor may remit success fees to the successful investor through the interaction facilitating platform.

Establishing an investment agreement between an investor and a trader requires that the two parties agree upon both the monetary amount to be invested, and the success fee rate to be rewarded to the trader. The success fee rate is the percentage of the monetary gain won on each successful trade that the investor will reward to the trader. To establish a agreement, the investor may pay a fee equivalent to a predetermined percentage of the investment amount to the interaction facilitating platform at the time the agreement is established. The percentage can depend on the duration of the agreement. The predetermined percentage can be about 4% or less, about 4%, about 5%, about 6% about 7% about 8%, or more than about 8%. More favorable rates can be offered for longer agreements. The investor may, however, choose to exit the investment and therefore nullify the agreement with the trader at any time. However, the investor may be warned that the fee he paid for establishing the agreement will not be refunded. The agreement may be nullified by the interaction facilitating platform, if the trader is not active for a predetermined period of time. In this case, the fee for establishing the agreement may be refunded to the investor. Also in establishing an agreement, the investor may agree to donate a predetermined percentage of his or her gains to a charity of his or her choice. The donation can be made in the name of the interaction facilitating platform. The predetermined percentage of the investor's gain to donate to a charity can be about 4% or less, about 4%, about 5%, about 6% about 7% about 8%, or more than about 8%.

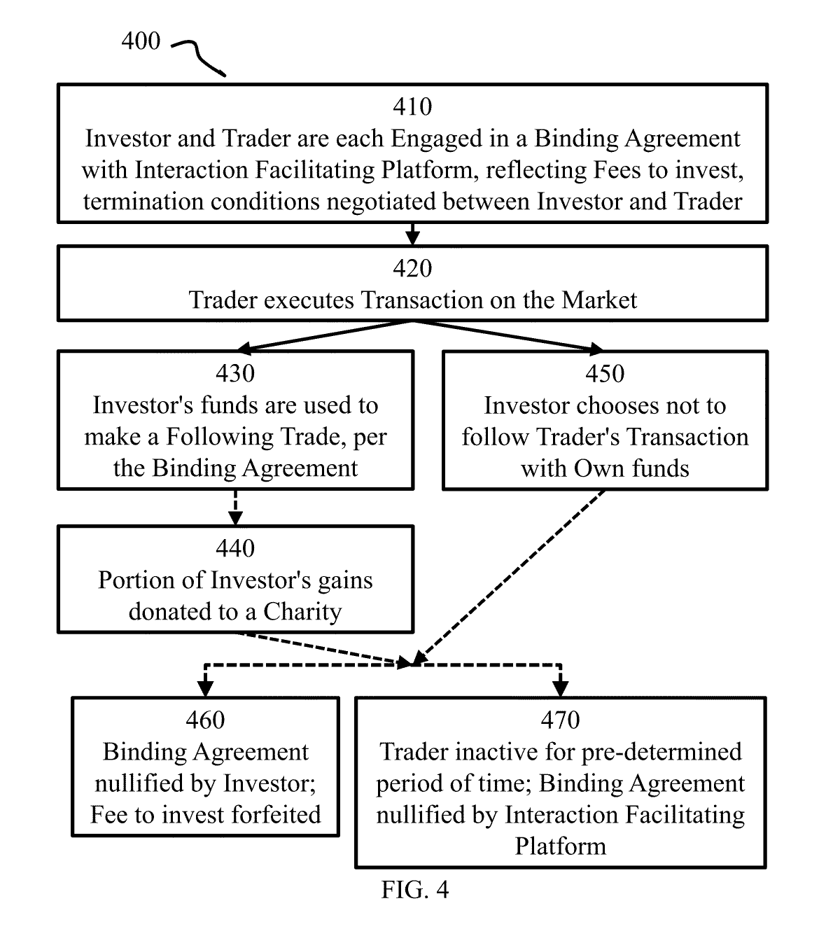

FIG. 4 is a flow diagram 400 showing actions that can take place in an exemplary system with an investor, a trader, an interaction facilitating platform, and a market, in this example, a currency exchange market. In the interaction that takes place via the interaction facilitating platform, the individual investor and trader can each be engaged in a binding agreement with the interaction facilitating platform, as shown in 410. The binding agreement can include definitions of the fees, termination conditions, and the like, as described above. The binding agreement can be a written contract, an electronically executed agreement, or any other suitable type of binding agreement. After the establishment of a binding agreement between the interaction facilitating platform and the investor, and similarly between the interaction facilitating platform and trader, (box 410), the trader executes a market transaction, such as a transaction involving at least two currencies on the currency exchange market, as in box 420. At this point, FIG. 4 shows two possible subsequent actions.

Box 430 shows that per the terms of the binding agreement, the interaction facilitating platform can cause some of the investor's funds to be sinvested in a “following” trade, as defined above. Alternatively, as shown in box 450, the individual investor can choose not to emulate the trader's transaction with his or her own funds. This inaction may not generate any fees to be paid by either party.

After some time, if the “following” trade made according to box 430 generates gains for the individual investor, a portion of those gains can be donated to a charity, as shown in box 440. The binding agreement can be nullified at any time by the individual investor; as shown in box 460, the individual investor nullified the binding agreement either after receiving some gains from investments or after choosing not to engage in a “following” trade. The binding agreement may also be nullified due to inactivity of the trader for a pre-determined time period, as shown in box 470 and described previously herein.

It is possible for an individual investor to invest with more than one trader at a time. The investor can allot only a specific portion of his or her entire foreign currency exchange account to following the trades of a given trader. Providing that there is still a non-invested portion of the foreign currency exchange account still available, the investor can choose to invest a part of the non-invested portion with another trader, and so on, until the investor has no non-invested portion left.

For example, although an investor has a single Forex account (i.e. foreign currency exchange account), his or her full account size does not need to be made available to each trader that he or she invests with. Before choosing to invest with a trader, the individual investor can choose to limit the size of his or her investment, and therefore allot only a desired portion of his or her account to be made available for following the trades of that particular trader. This process can ensure that the individual investor will only risk the agreed upon portion of his or her foreign currency exchange account in trades following a certain trader. In addition, this process allows the individual investor to invest in more than a single trader without having multiple foreign currency exchange accounts. The portion of the foreign currency exchange account to be invested can be defined as a monetary amount and can be outlined in a binding agreement between the investor and the trader. Inclusion of a specific amount of money in the binding agreement between the individual investor and trader can guarantee that the agreed upon monetary amount will be allotted to following trades with the given trader. In some implementations, the minimum amount that can be invested with a given trader must be greater than or equal to the minimum investment amount defined by that trader. Each trader can customize his or her own minimum investment amount desired, which can be greater than or equal to the minimum investment amount defined by the interaction facilitating platform.

Though the systems and methods above are described primarily in terms of currency exchange, particularly foreign currency exchange, such systems and methods can be used with or applicable to markets or systems that trade in stocks, bonds, futures, and/or commodities, as well as the Forex market. Any type of trading or exchange market in which professional traders operate on a frequent basis, such as a daily basis, can employ the systems and methods described herein.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. An interaction facilitating platform comprising:
an agreement processor to establish a binding agreement by an individual investor, the binding agreement defining investments to be made with funds associated with the individual investor based upon trade transactions by one or more traders in a market; and
a trading core processor that conveys interactions between the one or more traders and the individual investor, the interactions comprising trade transactions by the one or more traders in the market, the trade transactions including a mimicked trade on behalf of the individual investor that mimics at least one of the trade transactions by the one or more traders in the market.

2. The interaction facilitating platform in accordance with claim 1, further comprising a display processor for generating a visual display of the trade transactions by the one or more traders.

3. The interaction facilitating platform in accordance with claim 2, wherein the trading core processor transmits the visual display of the trade transactions to a display device associated with the individual investor.

4. The interaction facilitating platform in accordance with claim 1, wherein the agreement processor includes a screening module for pre-screening the one or more traders or the individual investor according to a set of pre-screening attributes.

5. The interaction facilitating platform in accordance with claim 4, wherein the pre-screening attributes include work history, education, and certifications.

6. The interaction facilitating platform in accordance with claim 4, wherein the pre-screening attributes include a predetermined range of percentages of gains from an investment made by the individual investor who has entered into the binding agreement.
